(19) United States
(12) Patent Application Publication
(10) Pub. No.: US 2025/0023806 A1
(43) Pub. Date: Jan. 16, 2025

(54) COMMUNICATION DEVICE, ROUND-TRIP TIME ESTIMATION METHOD, AND ROUND-TRIP TIME ESTIMATION PROGRAM

(71) Applicant: DENSO CORPORATION, Kariya-city (JP)

(72) Inventor: Tsuneo NAKATA, Kariya-city (JP)

(21) Appl. No.: 18/764,425

(22) Filed: Jul. 5, 2024

(30) Foreign Application Priority Data
Jul. 11, 2023 (JP) 2023-113755

(51) Int. Cl. H04L 43/0864; H04L 43/0829

(52) U.S. Cl. CPC H04L 43/0864; H04L 43/0841

(57) ABSTRACT

By a communication device, a round-trip time estimation method, or a non-transitory computer-readable storage medium storing a round-trip time estimation program, sequence information of a communication packet and a reception confirmation packet are acquired, a round-trip time is estimated based on an acquisition result and three timings: two transmission times and a reception time.

### CROSS REFERENCE TO RELATED APPLICATION

The present application claims the benefit of priority from Japanese Patent Application No. 2023-113755 filed on Jul. 11, 2023. The entire disclosure of the above application is incorporated herein by reference.

### TECHNICAL FIELD

The present disclosure relates to a communication device, a round-trip time estimation method, and a non-transitory computer-readable storage medium storing a round-trip time estimation method program.

### BACKGROUND

In packet communication, a communication device transmits a communication packet to a counterpart device, and upon receiving the communication packet from the communication device, the counterpart device transmits a reception confirmation packet for the communication packet to the communication device. A technology of a comparative example estimates a round-trip time (hereinafter sometimes referred to as RTT) based on a transmission time of the communication packet and a reception time of the reception confirmation packet when sequence information of a communication packet transmitted from a communication device to a counterpart device matches sequence information of the reception confirmation packet transmitted from the counterpart device to the communication device.

### SUMMARY

By a communication device, a round-trip time estimation method, or a non-transitory computer-readable storage medium storing a round-trip time estimation program, sequence information of a communication packet and a reception confirmation packet are acquired, a round-trip time is estimated based on an acquisition result and three timings: two transmission times; and a reception time.

### BRIEF DESCRIPTION OF THE DRAWINGS

FIG. 1 is a functional block diagram showing an overall configuration according to an embodiment.

FIG. 2 is a flowchart showing a RTT estimation process according to a first method.

FIG. 3 is a diagram illustrating the RTT estimation process according to the first method.

FIG. 4 is a diagram illustrating the RTT estimation process according to the first method.

FIG. 5 is a flowchart showing a RTT estimation process according to a second method.

FIG. 6 is a diagram illustrating the RTT estimation process according to the second method.

FIG. 7 is a diagram illustrating the RTT estimation process according to the first method.

FIG. 8 is a flowchart showing an estimation process for a lower limit of a RTT fluctuation range.

FIG. 9 is a diagram illustrating the estimation process for the lower limit of the RTT fluctuation range.

FIG. 10 is a diagram illustrating the estimation process for the lower limit of the RTT fluctuation range.

### DETAILED DESCRIPTION

In a method of the comparative example, in order to identify the reception confirmation packet that matches the sequence information of a communication packet, it is necessary to determine the sequence information of a plurality of reception confirmation packets, including those before and after the reception confirmation packet with the matching sequence information. Therefore, the processing load increases. Further, even in the case where the reception confirmation packet that matches the sequence information of the communication packets is identified, when the reception confirmation packet is a delayed packet or a duplicate packet, the accuracy of the RTT estimation decreases.

Examples of the present disclosure provide a communication device, a round-trip time estimation method, and a non-transitory computer-readable storage medium storing a round-trip time estimation program capable of appropriately estimating a round-trip time.

According to one example embodiment, a communication packet is transmitted to a counterpart device and a reception confirmation packet for the communication packet is received from the counterpart device. A sequence information acquisition unit acquires sequence information of the communication packet and the reception confirmation packet. A round-trip time estimation unit estimates a round-trip time based on an acquisition result by the sequence information acquisition unit and three timings: a transmission time of at least one of the communication packet; a reception time of one reception confirmation packet; and a transmission time of another communication packet or a reception time of another reception confirmation packet.

The round-trip time is estimated based on three timings of the transmission time of at least one communication packet, the reception time of one reception confirmation packet, and either the transmission time of another communication packet or the reception time of another reception confirmation packet. There is no need to determine the sequence information of a plurality of reception confirmation packets including those before and after the reception confirmation packet with the matching sequence information, and it is possible to avoid an increase in the processing load. There is no need to identify the reception confirmation packet that matches the sequence information of the communication packet, and it is possible to avoid a decrease in the accuracy of the RTT estimation. It is possible to avoid both the increase in the processing load and the decrease in the estimation accuracy, and it is possible to appropriately estimate the round-trip time.

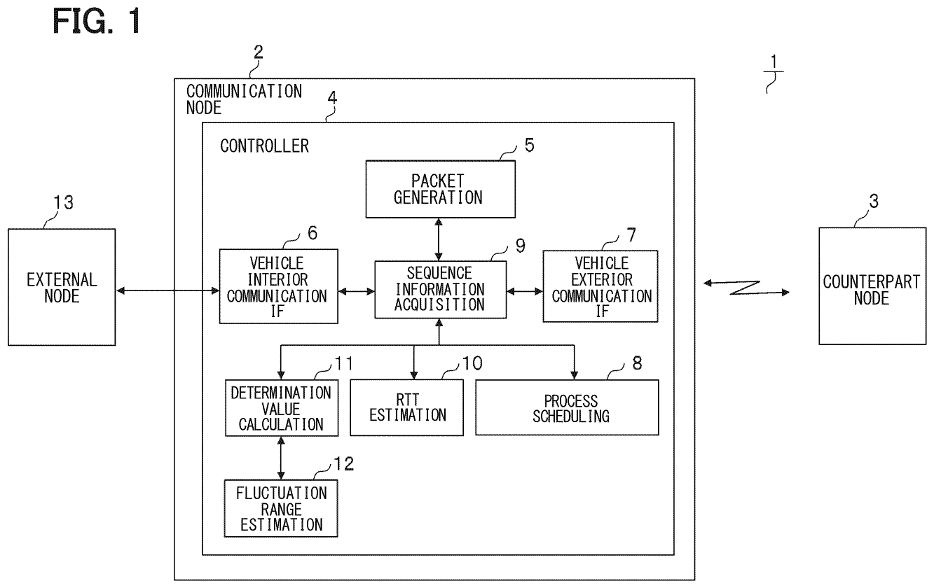

Hereinafter, an embodiment in which the present disclosure is applied to a communication node mounted on, for example, a vehicle will be described with reference to the drawings. As shown in FIG. 1, a communication system 1 is configured to communicate data between a communication node 2 (corresponding to a communication device) and a counterpart node 3 (corresponding to a counterpart device) via a wireless line. The data communication performed between the communication node 2 and the counterpart node 3 is based on the TCP/IP (Transmission Control Protocol/Internet Protocol) communication protocol. The communication node 2 transmits a communication packet to the counterpart node 3 via a wireless line. When the counterpart node 3 receives a communication packet from the communication node 2, the destination node 3 transmits a reception confirmation packet in response to the received communication packet to the communication node 2 via a wireless line. Here, the communication node 2 and the counterpart node 3 may be able to communicate data via a base station, and the communication node 2 and the base station may perform data communication via a wireless line, and the counterpart node 3 and the base station may perform data communication via a wired line.

The communication node 2 transmits to, the counterpart node 3, travel control data relating to travel control such as vehicle speed, acceleration/deceleration, sharp turns, travel route, and fuel efficiency. The counterpart node 3 is capable of data communication with a plurality of communication nodes 2 via wireless lines, and is, for example, a server having a function of executing a statistical process on the travel control data for an unspecified number of vehicles. When the counterpart node 3 receives the travel control data from each of the communication nodes 2 mounted on an unspecified number of vehicles, the counterpart node 3 executes the statistical process on the received travel control data. The data transmitted and received between the communication node 2 and the counterpart node 3 may be data other than the above-described travel control data, and may be data used for other purposes.

The communication node 2 includes a controller 4 that controls the operation of the entire nodes. The controller 4 is provided by a microcomputer having a CPU (i.e., Central Process Unit), a ROM (i.e., Read Only Memory), a RAM (i.e., Random Access Memory), and an I-O (i.e., Input-Output). A function provided by the controller 4 can be provided by software stored in a tangible memory device and a computer that executes the software, only software, only hardware, or a combination thereof. For example, when the controller 4 is provided by an electronic circuit that is hardware, the controller 4 can be provided by a digital circuit including a large number of logic circuits or an analog circuit. When the controller 4 executes the program stored in the non-transitory tangible storage medium, a process corresponding to the program is executed, and a method corresponding to the program is executed.

The controller 4 includes, for each function, a packet generation unit 5, a vehicle interior communication interface unit 6 (corresponding to a packet reception unit), a vehicle exterior communication interface unit 7, a process scheduling unit 8, a sequence information acquisition unit 9, a RTT estimation unit 10, a determination value calculation unit 11, and a fluctuation range estimation unit 12. Each of these units 5 to 12 executes an RTT estimation program and performs an RTT estimation method.

The packet generation unit 5 generates a communication packet according to the execution of the application by the controller 4, and outputs the generated communication packet to the sequence information acquisition unit 9. When the vehicle interior communication interface unit 6 receives a communication packet from an external node 13 (corresponding to an external device), the vehicle interior communication interface unit 6 outputs the received communication packet to the sequence information acquisition unit 9.

The vehicle exterior communication interface unit 7 transmits the communication packet to the counterpart node 3 via the wireless line. The process scheduling unit 8 schedules the processing of the communication packet and the reception confirmation packet. When the processes of the communication packet and the reception confirmation packet are scheduled by the process scheduling unit 8, the sequence information acquisition unit 9 acquires the sequence numbers (corresponding to sequence information) of the communication packet and the reception confirmation packet whose processing are scheduled. The sequence number is information capable of specifying the transmission order of the communication packet and the reception order of the reception confirmation packet, respectively. As long as it is possible to specify the transmission order of the communication packet and the reception order of the reception confirmation packet, information other than the sequence number may be used instead of the sequence number.

When the sequence information acquisition unit 9 acquires the sequence numbers of the communication packet and the reception confirmation packet, the RTT estimation unit 10 estimates the RTT based on the acquired results, that is, the transmission time of the communication packet and the reception time of the reception confirmation packet. There are two RTT estimation methods of: a first method for estimating the RTT based on the transmission time of one communication packet and the reception time of two reception confirmation packets, and a second method for estimating the RTT based on the transmission time of two communication packets and the reception time of one reception confirmation packet.

In the first method, the RTT estimation unit 10 performs the following on the condition that two reception confirmation packets are received after one communication packet is transmitted. The RTT is estimated when the sequence number of the later reception confirmation packet matches the sequence number of the communication packet, or when the sequence number between the sequence numbers of two reception confirmation packets matches the sequence number of the communication packet. In the second method, the RTT estimation unit 10 performs the following on the condition that one reception confirmation packet is received after two communication packets are transmitted. The RTT is estimated when the sequence number of an earlier communication packet matches the sequence number of the reception confirmation packet, or when the sequence number between two communication packets matches the sequence number of the reception confirmation packet.

The determination value calculation unit 11 calculates upper and lower limits of the RTT for each sample for a plurality of samples during a predetermined measurement period, and calculates the minimum value of the plurality of upper limits as the upper limit determination value and the maximum value of the plurality of lower limits as the lower limit determination value. When the upper limit determination value and the lower limit determination value are calculated by the determination value calculation unit 11, the fluctuation range estimation unit 12 compares the calculated upper limit determination value with the calculated lower limit determination value. When the upper limit determination value is smaller than the lower limit determination value, the difference between the upper limit determination value and the lower limit determination value is estimated as the lower limit of the RTT fluctuation range.

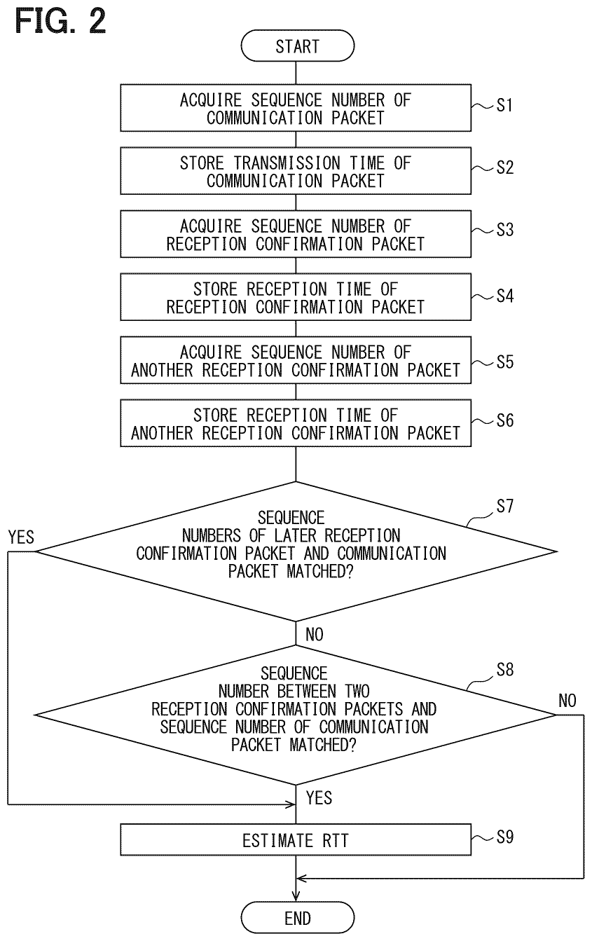

Next, the process of the above configuration will be described with reference to FIGS. 2 to 10. Here, the RTT estimation process for estimating the RTT and an RTT fluctuation range lower limit estimation process for estimating the lower limit of the RTT fluctuation range will be described.

### (1) RTT Estimation Process

As described above, there are two RTT estimation process methods of the first method and the second method. Each process will be described below.

### (1-1) RTT Estimation Process Using First Method (See FIGS. 2 to 4)

The controller 4 starts the RTT estimation process using the first method, and when a request to transmit the communication packet occurs, acquires the sequence number of the communication packet that is the subject of the request to transmit (S1, corresponding to a first information acquisition process). When the controller 4 transmits the communication packet to the counterpart node 3, the controller 4 stores the transmission time of the communication packet in association with the sequence number of the acquired communication packet (S2).

When the controller 4 receives the reception confirmation packet from the counterpart node 3, it acquires the sequence number of the received reception confirmation packet (S3, which corresponds to a second information acquisition process). The controller 4 stores the reception time of the reception confirmation packet in association with the sequence number of the acquired reception confirmation packet (S4).

When the controller 4 receives another reception confirmation packet from the counterpart node 3, it acquires the sequence number of the received another reception confirmation packet (S5, which corresponds to the second information acquisition process). The controller 4 stores the reception time of the another reception confirmation packet in association with the sequence number of the acquired another reception confirmation packet (S4).

The controller 4 determines whether the conditions for estimating the RTT are satisfied. The controller 4 determines whether the sequence number of the latter reception confirmation packet matches the sequence number of the communication packet (S7). When the controller 4 determines that there is a match (S7: YES), it estimates the RTT based on the three timings: the transmission time of one communication packet and the reception time of two reception confirmation packets (S9), and ends the RTT estimation process using the first method.

On the other hand, when the controller 4 determines that there is no match (S7: NO), it determines whether the sequence number between the sequence numbers of the two reception confirmation packets matches the sequence number of the communication packet (S8). When the controller 4 determines that there is the match (S8: YES), in this case too, it estimates the RTT based on the three timings: the transmission time of one communication packet and the reception times of two reception confirmation packets (S9), and ends the RTT estimation process using the first method. On the other hand, when the controller 4 determines that there is no match (S8: NO), the controller 4 ends the RTT estimation process using the first method without estimating the RTT.

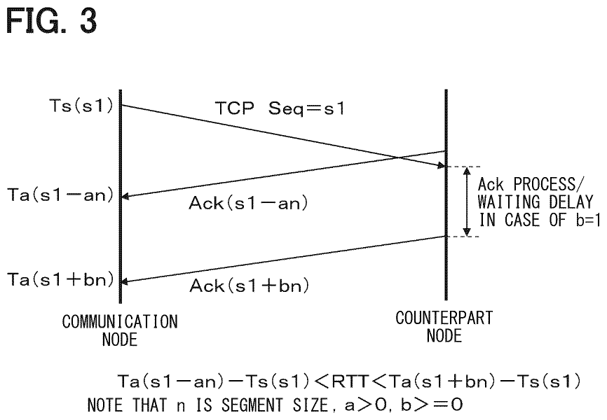

As shown in FIG. 3, the controller 4 sets “n” to the segment size, sets a>0 and b>=0, and transmits a communication packet having a sequence number “s1” to the another node 3 at a transmission time “Ts(s1)”. The controller 4 receives a reception confirmation packet with sequence number “s1−an” from the counterpart node 3 at a reception time “Ta(s1−an)”.When a reception confirmation packet with sequence number “s1+bn” is received from the counterpart node 3 at reception time “Ta(s1+bn)”, the controller 4 estimates the RTT by the following expression.

$$Ta ( s 1 - an ) - Ts ( s 1 ) < RTT < Ta ( s 1 + bn ) - Ts ( s 1 )$$

That is, the controller 4 estimates that the RTT is within a range having Ta(s1−an)-Ts(s1) as the lower limit and Ta(s1+bn)-Ts(s1) as the upper limit.

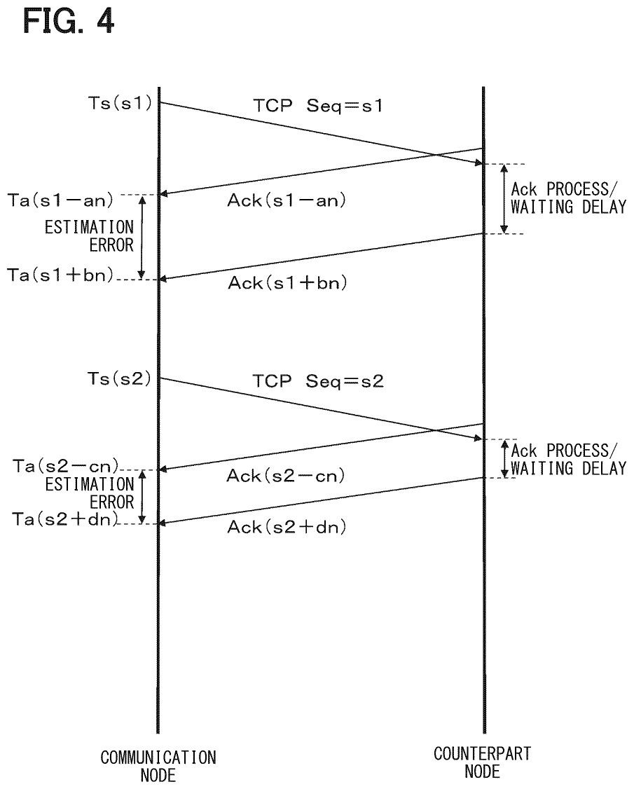

The controller 4 calculates the difference between the upper limit and the lower limit of the RTT for each sample as an estimation error for a plurality of samples in a predetermined measurement period. As shown in FIG. 4, the controller 4 estimates the difference between the upper limit and the lower limit associated with the transmission of a communication packet having the sequence number “s1” as an estimation error using the following calculation equation.

$$Estimation error = Ta ( s 1 + bn ) - Ta ( s 1 - an )$$

When the controller 4 transmits a communication packet with sequence number “s2” following the transmission of the communication packet with the sequence number “s1”, it sets c>0, d>=0 and similarly estimates the RTT using the following calculation expression.

$$Ta ( s 2 - cn ) - Ts ( s 2 ) < R T T < T a ( s 2 + d n ) - Ts ( s 2 )$$

That is, the controller 4 estimates that the RTT is within a range whose lower limit is Ta(s2−cn)−Ts(s2) and whose upper limit is Ta(s2+dn)−Ts(s2).

The controller 4 estimates the difference between the upper limit and the lower limit associated with the transmission of a communication packet having the sequence number “s2” as an estimation error using the following calculation equation.

$$Estimation error = Ta ( s 1 + dn ) - Ta ( s 1 - cn )$$

After calculating the estimation error for each of a plurality of samples in this manner, the controller 4 estimates the RTT for a sample for which the calculated estimation error is relatively small. The controller 4 executes the statistical process on samples whose estimation error is less than x % of the average of all samples as valid samples, and estimates the RTT. The “x” is, for example, a value that satisfies the estimation accuracy required for the system. In the example of FIG. 4, the estimation error of the communication packet sample with sequence number “s2” is smaller than that of the communication packet sample with sequence number “s1”. Therefore, there is a high possibility that the communication packet sample with sequence number “s2” is adopted as a valid sample.

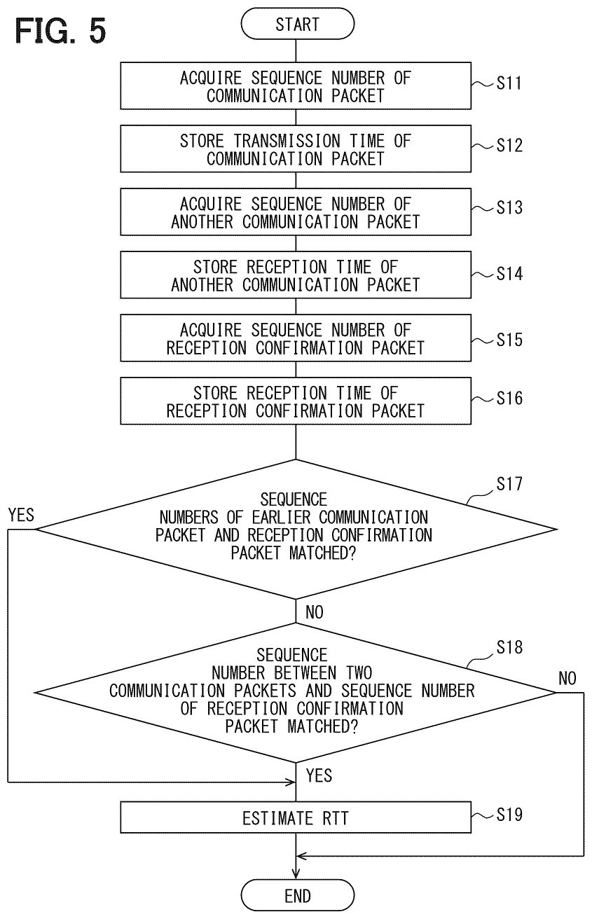

### (2) RTT Estimation Process Using Second Method (See FIGS. 5 to 7)

The controller 4 starts the RTT estimation process using the second method, and when a request to transmit the communication packet occurs, acquires the sequence number of the communication packet that is the subject of the request to transmit (S11, corresponding to a first information acquisition process). When the controller 4 transmits the communication packet to the counterpart node 3, the controller 4 stores the transmission time of the communication packet in association with the sequence number of the acquired communication packet (S12).

When a request to transmit another communication packet occurs, the controller 4 acquires the sequence number of the another communication packet that is the subject of the request to transmit (S13, corresponding to a first information acquisition process). When the controller 4 transmits another communication packet to the counterpart node 3, the controller 4 stores the transmission time of the communication packet in association with the sequence number of the acquired another communication packet (S14).

When the controller 4 receives the reception confirmation packet from the counterpart node 3, it acquires the sequence number of the received reception confirmation packet (S15, which corresponds to a second information acquisition process). The controller 4 stores the reception time of the reception confirmation packet in association with the sequence number of the acquired reception confirmation packet (S16).

The controller 4 determines whether the conditions for estimating the RTT are satisfied. The controller 4 determines whether the sequence number of the earlier communication packet matches the sequence number of the reception confirmation packet (S17). When the controller 4 determines that there is a match (S7: YES), it estimates the RTT based on the three timings: the transmission time of two communication packets and the reception time of one reception confirmation packet (S19), and ends the RTT estimation process using the second method.

On the other hand, when the controller 4 determines that there is no match (S17: NO), it determines whether the sequence number between the sequence numbers of the two communication packets matches the sequence number of the reception confirmation packet (S18). When the controller 4 determines that there is the match (S18: YES), in this case too, it estimates the RTT based on the three timings the transmission times of two communication packets and the reception time of one reception confirmation packet (S19), and ends the RTT estimation process using the second method. On the other hand, when the controller 4 determines that there is no match (S18: NO), the controller 4 ends the RTT estimation process using the second method without estimating the RTT.

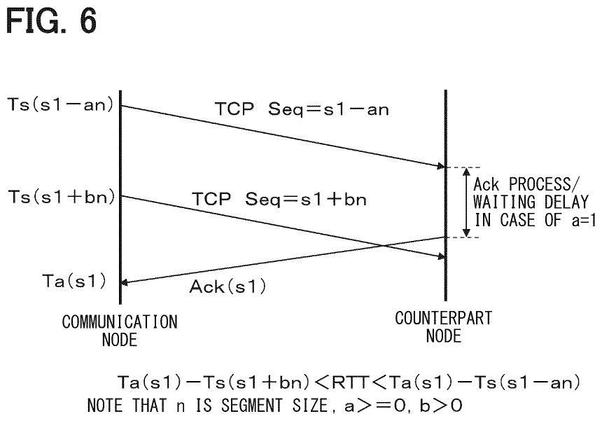

As shown in FIG. 6, the controller 4 sets “n” to the segment size, sets a>=0, and sets b>=0, and transmits a communication packet having a sequence number “s1−an” to the another node 3 at a transmission time “Ts(s1−an)”. The controller 4 transmits a communication packet with sequence number “s1+bn” to the counterpart node 3 at a transmission time “Ta(s1+bn)”.When a reception confirmation packet with a sequence number “s1” is received from the counterpart node 3 at a reception time “Ta(s1)”, the controller 4 estimates the RTT by the following expression.

$$Ta ( s 1 ) - Ts ( s 1 + bn ) < RTT < T a ( s 1 ) - T s ( s 1 - an )$$

That is, the controller 4 estimates that the RTT is within a range having Ta(s1)−Ts(s1+bn) as the lower limit and Ta(s1)−Ts(s1−an) as the upper limit.

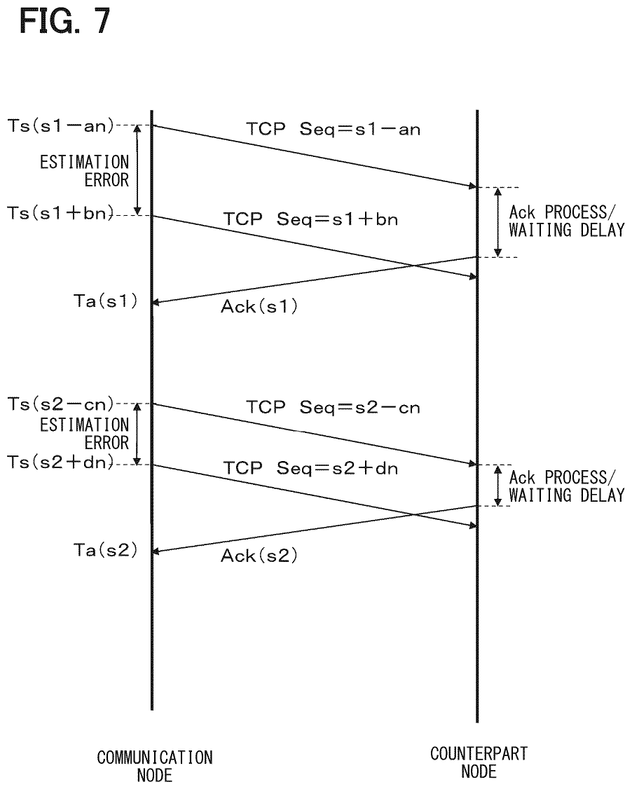

Also in this case, the controller 4 calculates the difference between the upper limit and the lower limit of the RTT for each sample as an estimation error for a plurality of samples in a predetermined measurement period. As shown in FIG. 7, the controller 4 estimates the difference between the upper limit and the lower limit associated with the reception of the reception confirmation packet having the sequence number “s1” as the estimation error using the following calculation equation.

$$Estimation error = Ts ( s 1 + bn ) - Ts ( s 1 - an )$$

The controller 4 transmits the reception confirmation packets with sequence numbers “s1−an” and “s1+bn”, and subsequently transmits the reception confirmation packets with sequence numbers “s1−cn” and “s1+dn”. Then, the controller 4 sets c>=0 and d>0, and estimates the RTT by the following calculation expression.

$$Ta ( s 2 ) - Ts ( s 2 + dn ) < R T T < T a ( s 2 ) - T s ( s 2 - cn )$$

That is, the controller 4 estimates that the RTT is within a range whose lower limit is Ta(s2)−Ts(s2+dn) and whose upper limit is Ta(s2)−Ts(s2−cn).

The controller 4 estimates the difference between the upper limit and the lower limit associated with the reception of the reception confirmation packet having the sequence number “s2” as an estimation error using the following calculation equation.

$$Estimation error = Ts ( s 2 + dn ) - Ts ( s 2 - cn )$$

After calculating the estimation error for each of a plurality of samples in this manner, the controller 4 estimates the RTT for a sample for which the calculated estimation error is relatively small. The controller 4 executes the statistical process on samples whose estimation error is less than x % of the average of all samples as valid samples, and estimates the RTT. In the example of FIG. 7, the estimation error of the reception confirmation packet sample with the sequence number “s2” is smaller than that of the reception confirmation packet sample with the sequence number “s1”. Therefore, there is a high possibility that the reception confirmation packet sample with the sequence number “s2” is adopted as a valid sample.

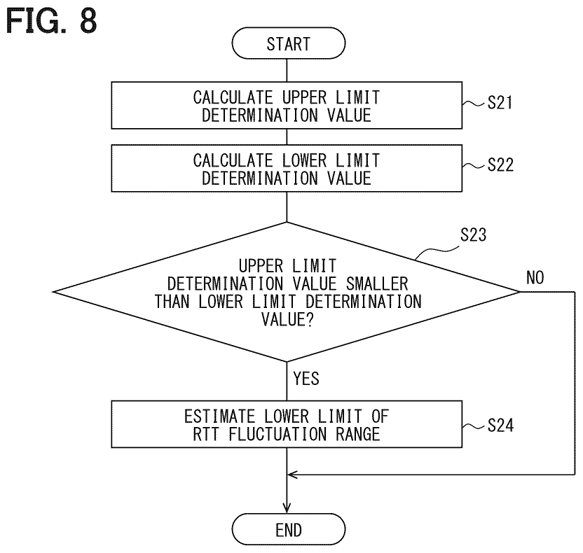

### (2) RTT Fluctuation Range Lower Limit Estimation Process (See FIGS. 8 to 10)

When the controller 4 starts the RTT fluctuation range lower limit estimation process, it calculates the upper and lower limits of the RTT for each of a plurality of samples in a predetermined measurement period. The controller 4 calculates the minimum value of the plurality of calculated upper limits as the upper limit determination value (S21), and calculates the maximum value of the plurality of calculated lower limits as the lower limit determination value (S22).

The controller 4 compares the upper limit determination value with the lower limit determination value, and determines whether the upper limit determination value is smaller than the lower limit determination value (S23). When the controller 4 determines that the upper limit determination value is smaller than the lower limit determination value (S23: YES), it estimates the difference between the upper limit determination value and the lower limit determination value as the lower limit of the RTT fluctuation range (S24), and ends the RTT fluctuation range lower limit estimation process. On the other hand, when the controller 4 determines that the upper limit determination value is not smaller than the lower limit determination value (S23: NO), it ends the RTT fluctuation range lower limit estimation process without estimating the lower limit of the RTT fluctuation range.

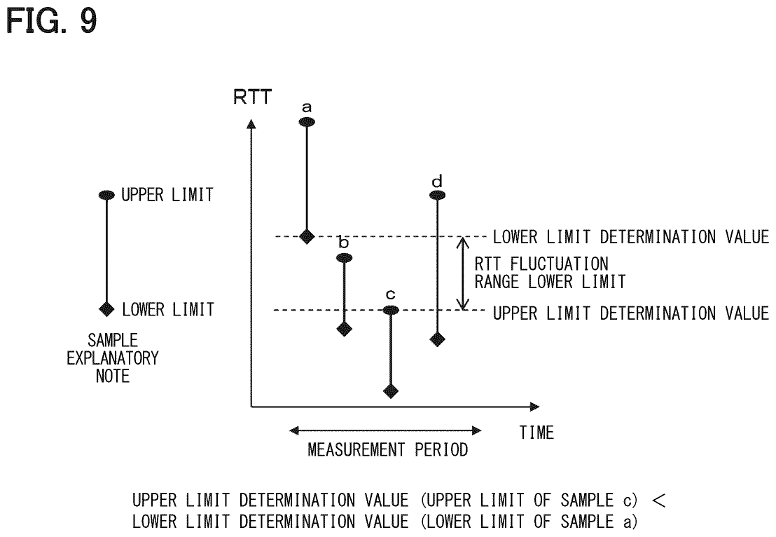

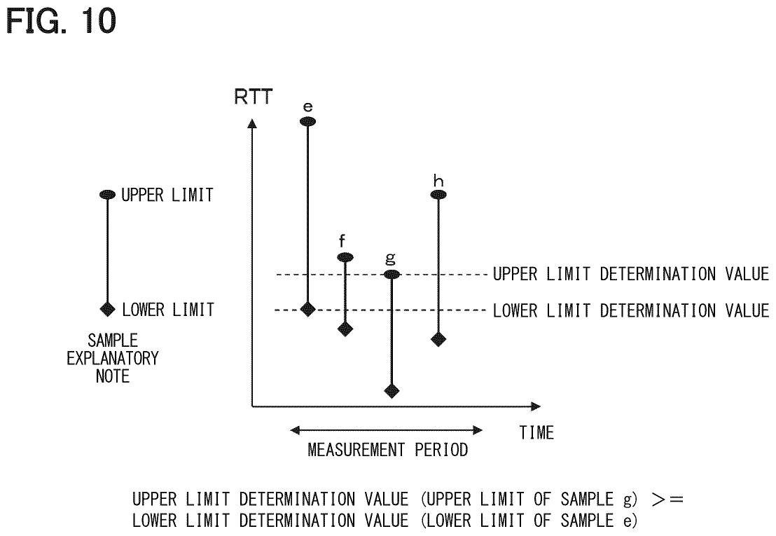

As shown in FIG. 9, for example, in a case where the number of samples a to d in a predetermined measurement period is four, when the controller 4 determines that the upper limit determination value is smaller than the lower limit determination value, the controller 4 estimates the difference between the upper limit determination value and the lower limit determination value as the lower limit of the RTT fluctuation range. On the other hand, as shown in FIG. 10, in a case where, for example, the number of samples e to h in a predetermined measurement period is four, when the controller 4 determines that the upper limit determination value is not smaller than the lower limit determination value, the controller 4 does not estimate the lower limit of the RTT fluctuation range.

The above-described embodiment can provide the following operational effects. In the communication node 2, the RTT is estimated based on three timings: the transmission time of at least one communication packet, the reception time of one reception confirmation packet, and either the transmission time of another communication packet or the reception time of another reception confirmation packet. There is no need to determine the sequence numbers of a plurality of reception confirmation packets including those before and after the reception confirmation packet with the matching sequence number, and it is possible to avoid an increase in the processing load. There is no need to identify the reception confirmation packet that matches the sequence number of the communication packet, and it is possible to avoid a decrease in the accuracy of the RTT estimation. It is possible to avoid both the increase in the processing load and the decrease in the estimation accuracy, and it is possible to appropriately estimate the RTT.

The condition is that two reception confirmation packets are received after one communication packet is transmitted. The RTT is estimated based on the transmission time of one communication packet and the reception time of two reception confirmation packets, when the sequence number of the later reception confirmation packet matches the sequence number of the communication packet, or when the sequence number between the sequence numbers of two reception confirmation packets matches the sequence number of the communication packet. It is possible to appropriately estimate the RTT using the transmission time of one communication packet and the reception times of two reception confirmation packets.

The condition is that one reception confirmation packets is received after two communication packets are transmitted. The RTT is estimated based on the transmission time of two communication packets and the reception time of one reception confirmation packet, when the sequence number of the earlier communication packet matches the sequence number of the reception confirmation packet, or when the sequence number between the sequence numbers of two communication packets matches the sequence number of the reception confirmation packet. The RTT can be appropriately estimated using the transmission time of two communication packets and the reception times of one reception confirmation packet.

The sequence number of the communication packet generated by the communication node 2 is obtained, and the RTT is estimated. With use of the sequence number of the communication packet generated by the communication node 2, it is possible to appropriately estimate the RTT.

The sequence number of a communication packet received from the external node 13 is acquired, and the RTT is estimated. With use of the sequence number of the communication packet received from the external node 13, it is possible to appropriately estimate the RTT.

The sequence numbers of the scheduled communication packets and the reception confirmation packets are obtained, and the RTT is estimated. It is possible to appropriately estimate the RTT using the sequence numbers of the scheduled communication packet and the reception confirmation packet.

The difference between the upper limit and the lower limit of the RTT for each sample is calculated as the estimation error for the plurality of samples in the predetermined measurement period. The RTT is estimated for samples with relatively small calculated estimation errors. By estimating the RTT using the sample with the relatively small estimation error, it is possible to reduce the effect of delay in the reception confirmation packet. It is possible to prevent erroneous detection of congestion before the occurrence.

The upper and lower limits of the RTT are calculated for each sample for a plurality of samples during a predetermined measurement period. The minimum value of the plurality of upper limits is calculated as the upper limit determination value, and the maximum value of the plurality of lower limits is calculated as the lower limit determination value. When the upper limit determination value is smaller than the lower limit determination value, the difference between the upper limit determination value and the lower limit determination value is estimated as the lower limit of the RTT fluctuation range. By estimating the difference between the upper and lower limit determination value as the lower limit of the RTT fluctuation range when the upper limit determination value is smaller than the lower limit determination value, it is possible to estimate the lower limit of the RTT fluctuation range caused by the delay of the line itself during a period in which the line condition is assumed to be constant. It is possible to improve the accuracy of estimating the RTT.

The controller and the method described in the present disclosure may be implemented by a special purpose computer created by configuring a memory and a processor programmed to execute one or more particular functions embodied in computer programs. Alternatively, the controller and the method described in the present disclosure may be implemented by a special purpose computer created by configuring a processor provided by one or more special purpose hardware logic circuits. Alternatively, the controller and the method described in the present disclosure may be implemented by one or more special purpose computers created by configuring a combination of a memory and a processor programmed to execute one or more particular functions and a processor provided by one or more hardware logic circuits. The computer programs may be stored, as instructions being executed by a computer, in a tangible non-transitory computer-readable medium.

Here, the process of the flowchart or the flowchart described in this application includes a plurality of sections (or steps), and each section is expressed as, for example, S1. Further, each section may be divided into several subsections, while several sections may be combined into one section. Furthermore, each section thus configured may be referred to as a device, module, or means.

1. A communication device configured to transmit a communication packet to a counterpart device and receive a reception confirmation packet for the communication packet from the counterpart device, the communication device comprising:
a sequence information acquisition unit configured to acquire sequence information of the communication packet and the reception confirmation packet; and a round-trip time estimation unit configured to estimate a round-trip time based on an acquisition result by the sequence information acquisition unit and three timings of:
a transmission time of at least one of the communication packet;
a reception time of one reception confirmation packet; and
a transmission time of another communication packet or a reception time of another reception confirmation packet.

2. The communication device according to claim 1, wherein
the round-trip time estimation unit sets a condition that two reception confirmation packets have been received after transmission of one communication packet,
the two reception confirmation packets include a later reception confirmation packet, and
the round-trip time is estimated based on a transmission time of one communication packet and a reception time of two reception confirmation packets, when sequence information of the later reception confirmation packet matches sequence information of the communication packet, or when sequence information between sequence information of the two reception confirmation packets matches the sequence information of the communication packet.

3. The communication device according to claim 1, wherein
the round-trip time estimation unit sets a condition that one reception confirmation packet has been received after transmission of two communication packets, and
the two communication packets include an earlier communication packet, and the round-trip time is estimated based on a transmission time of the two communication packets and a reception time of the one reception confirmation packet, when sequence information of the earlier communication packet matches sequence information of the reception confirmation packet, or when sequence information between sequence information of the two communication packets matches the sequence information of the reception confirmation packet.

4. The communication device according to claim 1, further comprising
a packet generation unit configured to generate a packet,
wherein
the sequence information acquisition unit is configured to acquire the sequence information of the communication packet generated by the packet generation unit.

5. The communication device according to claim 1, further comprising
a packet reception unit configured receive the communication packet from an external device,
wherein
the sequence information acquisition unit is configured to acquire sequence information of the communication packet received by the packet reception unit from the external device.

6. The communication device according to claim 1, further comprising
a scheduling unit configured to process the communication packet and the reception confirmation packet,
wherein
the sequence information acquisition unit is configured to acquire the communication packet and the reception confirmation packet on which processing has been scheduled by the scheduling unit.

7. The communication device according to claim 1, wherein
the round-trip time estimation unit is configured to
calculate, as an estimation error, a difference between an upper limit and a lower limit of the round-trip time for each of a plurality of samples in a predetermined measurement period, and
estimate the round-trip time for a sample for which the calculated estimation error is relatively small.

8. The communication device according to claim 1, further comprising
a determination value calculation unit configured to
calculate a plurality of upper limits and a plurality of lower limits of the round-trip time for a plurality of samples in a predetermined measurement period, and
calculate a minimum value of the plurality of upper limits as an upper limit determination value and a maximum value of the plurality of lower limits as a lower limit determination value; and
a fluctuation range estimation unit configured to, when the upper limit determination value calculated by the determination value calculation unit is smaller than the lower limit determination value, estimate a difference between the upper limit determination value and the lower limit determination value as a lower limit of a fluctuation range of the round-trip time.

9. A round-trip time estimation method comprising causing a communication device configured to transmit a communication packet to a counterpart device and receive a reception confirmation packet for the communication packet from the counterpart device, to:
acquire sequence information of the communication packet;
acquire sequence information of the reception confirmation packet; and
estimate a round-trip time based on an acquisition result and three timings of:
a transmission time of at least one of the communication packet;
a reception time of one reception confirmation packet; and
a transmission time of another communication packet or a reception time of another reception confirmation packet.

10. A non-transitory computer-readable storage medium storing a round-trip time estimation program causing a controller of a communication device configured to transmit a communication packet to a counterpart device and receive a reception confirmation packet for the communication packet from the counterpart device, to:
acquire sequence information of the communication packet;
acquire sequence information of the reception confirmation packet; and
estimate a round-trip time based on an acquisition result and three timings of:
a transmission time of at least one of the communication packet;
a reception time of one reception confirmation packet; and
a transmission time of another communication packet or a reception time of another reception confirmation packet.
